(19) United States
(12) Patent Application Publication
(10) Pub. No.: US 2021/0048083 A1
(43) Pub. Date: Feb. 18, 2021

(54) IMPROVEMENTS IN DAMPERS

(71) Applicant: TITUS D.O.O. DEKANI, DEKANI (SI)

(72) Inventors: Nejc Stravnik, Izola (SI); David Pecar, Pobegi (SI)

(21) Appl. No.: 16/963,174

(22) PCT Filed: Nov. 29, 2018
(86) PCT No.: PCT/EP2018/083032

§ 371 Date: Jul. 17, 2020

(30) Foreign Application Priority Data
Jan. 25, 2018 (GB) 1801231.0

(51) Int. Cl. F16F 9/19; F16F 9/32; F16F 9/36

(52) U.S. Cl. CPC F16F 9/19; F16F 9/20; F16F 9/368; F16F 9/3228

(57) ABSTRACT

A piston and cylinder type damper has a cylinder (12) with a longitudinal axis (x) containing damping fluid. A piston assembly (10) is mounted in the cylinder (12) for reciprocal movement along the axis (x). The piston assembly (10) divides the interior of the cylinder (12) into two chambers (A, B), and provides a pathway for flow of damping fluid between them. The pathway includes a control passage (24) for restricting flow of damping fluid across the piston assembly (10). A sealing element (21) is provided for selectively sealing the piston assembly (10) against the cylinder (12). The control passage (24) and the sealing element (21) are arranged to be positioned at axially spaced apart locations.

This invention relates to dampers.

According to the invention there is provided a piston and cylinder type damper with a cylinder containing damping fluid having a longitudinal axis and a piston assembly mounted therein for reciprocal movement along said axis, with the piston assembly dividing the cylinder into two chambers and providing a passageway for flow of damping fluid therebetween, the passageway including a control passage for restricting flow of damping fluid, and a sealing element for selectively sealing the piston assembly against the cylinder, with the control passage and the sealing element being positioned at axially spaced apart locations.

By way of example, an embodiment of the invention will now be described with reference to the accompanying drawings, in which:

FIG. 1 is a cross-sectional view of a first form of damper according to the invention,

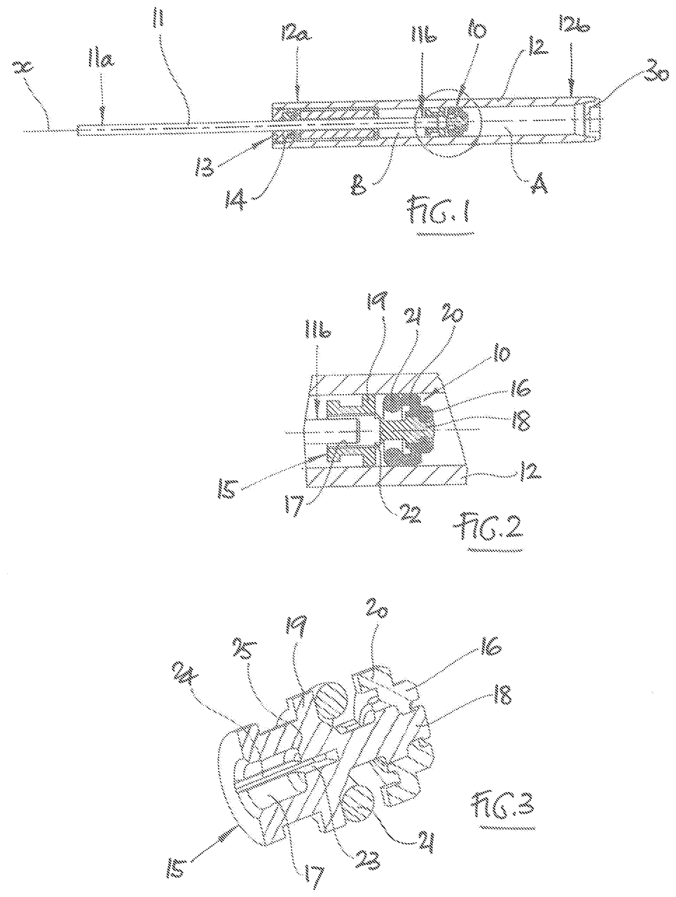

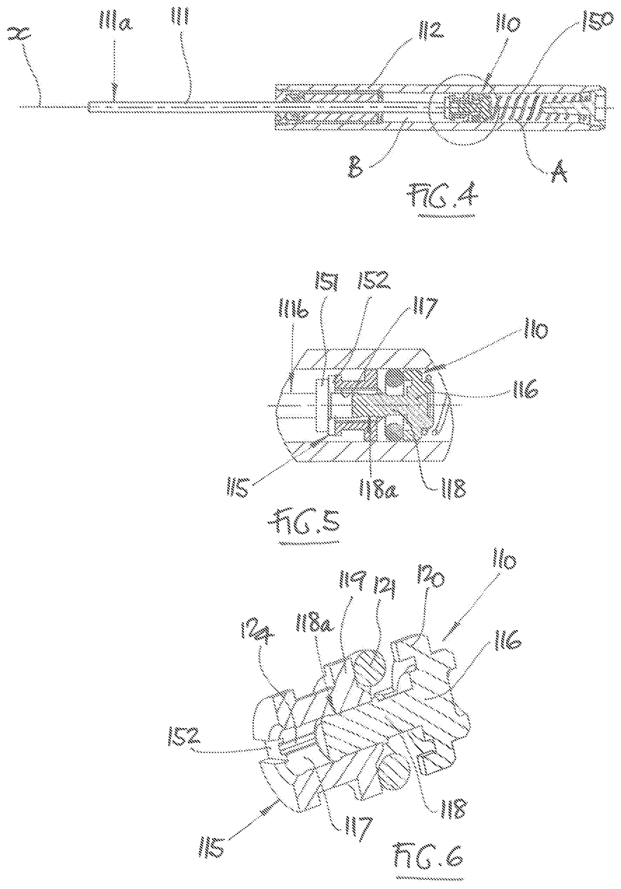

FIGS. 2 and 3 are cross-sectional detail views of the piston assembly of the damper of FIG. 1,

FIG. 4 is a cross-sectional view of a second form of damper according to the invention,

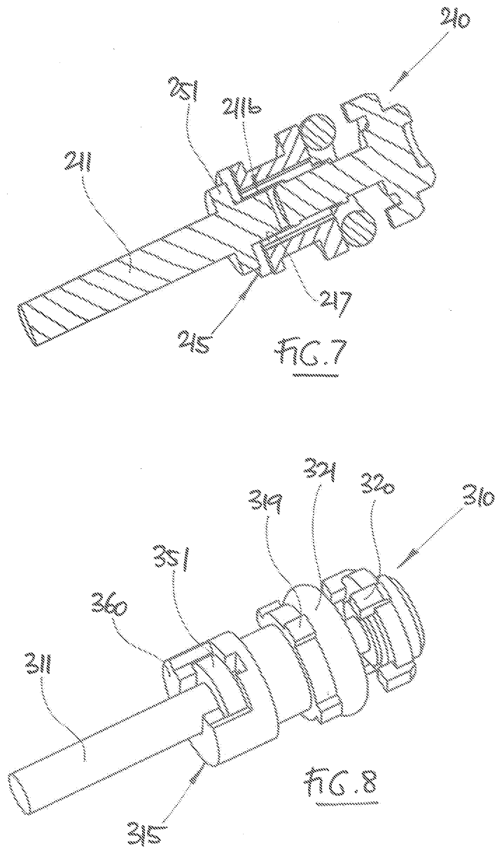

FIGS. 5 and 6 are cross-sectional detail views of the piston assembly of the damper of FIG. 4,

FIG. 7 is a cross-sectional detail view of an alternative form of piston assembly for the damper of FIG. 4,

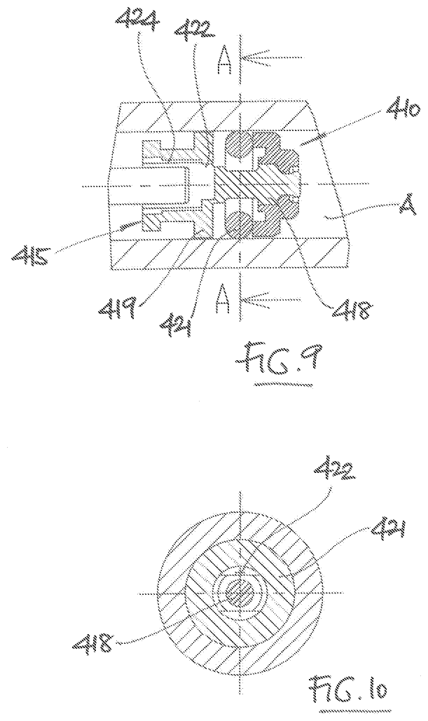

FIG. 8 is a cross-sectional detail view of an alternative form of piston assembly for the damper of FIG. 1,

FIG. 9 is a cross-sectional view of an alternative form of piston assembly,

FIG. 10 is a sectional view of the piston assembly of FIG. 9 along the lines A-A,

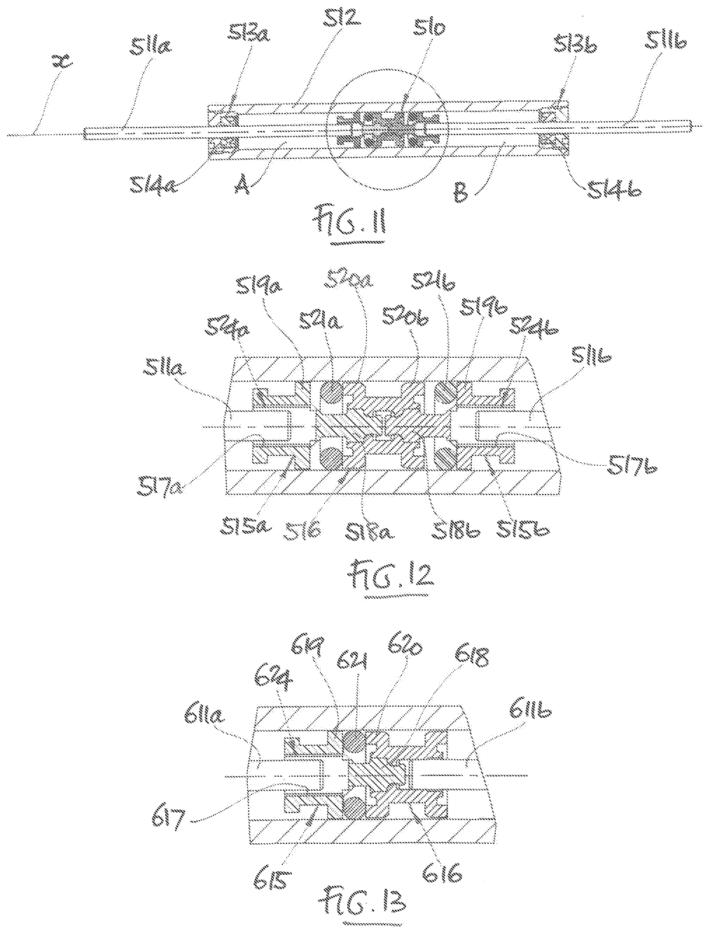

FIG. 11 is a cross-sectional view of a third form of damper according to the invention,

FIG. 12 is a cross sectional detail view of the piston assembly of the damper of FIG. 11, and

FIG. 13 is a cross sectional detail view of an alternative form of piston assembly for the damper of FIG. 11.

The damper seen in FIG. 1 is a linear piston and cylinder type damper of conventional circular cross-sectional form. The damper has a longitudinal axis x, a piston assembly 10, a piston rod 11 and a cylinder 12. The cylinder 12 contains damping fluid, such as oil or silicone. The piston rod 11 is mounted for reciprocal movement with respect to the cylinder 12 along its longitudinal axis x. A free end 11a of the piston rod 11 extends out of one end 12a of the cylinder 12, which is closed off by a seat assembly 13. The seat assembly 13 provides support for the slidable mounting of the piston rod 11 and a suitable seal 14 to prevent leakage of damping fluid out of the cylinder 12. The cylinder 12 is closed off at its other end 12b by a cover 30.

The other end 11b of the piston rod 11 extends into the interior of the cylinder 12 where it engages the piston assembly 10. The piston assembly 10 divides the interior of the cylinder 12 into two separate chambers A and B, with a passageway for flow of damping fluid between them, as will be described in more detail below.

The piston assembly 10 is seen in greater detail in FIGS. 2 and 3. It will be seen that it is made in two parts: an elongate valve body 15 and a cap 16. The valve body 15 has an axially extending bore 17 at one end, which receives the inner end 11b of the piston rod 11. At its other end the valve body 15 has an axially extending spigot 18 to which the cap 16 is attached. The cap 16 conveniently attaches to the spigot 18 by means of a snap-fit connection, both parts being made of suitable plastics material to allow this.

The valve body 15 has a radially outwardly extending flange 19. The flange 19 is of a castellated type of construction, with a number of teeth extending out to an overall outer diameter just slightly less than the bore of the cylinder 12, with reduced diameter segments in between (a flange 319 of this kind of construction can be seen more clearly in FIG. 8). The reduced diameter segments form part of the passageway for flow of damping fluid past the piston assembly 10, and their relatively large cross-sectional area means that they provide minimal resistance to this flow. The teeth on the flange 19 co-operate with the bore of the cylinder 12, which helps to guide the axial movement of the piston assembly 10.

The cap 16 also has a radially outwardly extending flange 20 of a similar castellated type construction. A sealing element in the form of an O-ring 21 is captured between the two flanges 19, 20. The spacing between the flanges 19, 20 allows a limited amount of axial movement of the O-ring 21 with respect to the piston assembly 10. The O-ring 21 is in sealing engagement with the bore of the cylinder 12, and its axial movement is used in controlling flow of damping fluid between the chambers A and B in operation of the damper, as will be described in more detail below.

The passageway that allows flow of damping fluid across the piston assembly 10 includes ports 22 in the valve body 15 (see FIG. 2) that are open to chamber A and that lead into the bore 17 via apertures 23 in the valve body (see FIG. 3). The apertures 23 in turn lead into axially extending grooves 24 in the bore 17 of the valve body 15 that are open to chamber B. In this case, there are two ports 22, arranged as a diametrically opposite pair, with the apertures 23 and the grooves 24 likewise being arranged as diametrically opposing pairs. The inner end 11b of the piston rod 11 is designed to be received within the bore 17 so as to occlude it, leaving just the grooves 24 as open pathways. In this way, the grooves 24 effectively constitute a restricted passage, and this is what is used to control flow of fluid from chamber A to chamber B in operation of the damper.

Control of the fluid flow is governed partly by the combined cross-sectional area of the grooves 24 and partly by their axial length. The length of the grooves 24 is determined by the extent to which the piston rod 11 extends into the bore 17, and this is determined by the position of an inner shoulder 25 in the bore against which the inner end 11b of the piston rod abuts.

It has been found to be advantageous to design the restricted passage in the form described above, because it is easier to control its manufacture on a production line within acceptable tolerances than it is by other means, such as by producing small holes. The design also has the benefit of allowing dampers with different damping characteristics to be produced using essentially the same modular parts, for example by simply varying the position of the shoulder 25 within the valve body 15 to vary the length of the grooves 24 and/or using different coring to vary the cross-sectional area of the grooves.

The damper seen here is designed to provide a damped resistance on its working stroke, which is upon axial movement of the piston rod 11 into the cylinder 12. It is further designed to provide minimal damped resistance on its return stroke, which is upon extension of the piston rod out of the cylinder. The damping is controlled by the O-ring 21. On the working stroke, the O-ring 21 will be picked up by the flange 19 on the valve body 15 as the piston rod 11 moves into the cylinder 12. This is the position seen in FIG. 3. In this position, the O-ring 21 creates a seal between the flange 19 and the bore of the cylinder 12. This means that the only passageway for fluid forced out of chamber A to flow across the piston assembly 10 is via the restricted passage, ie the grooves 24. Hence, a damped resistive force is generated against this movement.

On the return stroke, the O-ring 21 will be released from the flange 19 as the piston rod 11 moves out of the cylinder 12, thus allowing fluid to flow freely past it via the reduced diameter segments in the flange 19. This is the position seen in FIG. 2. Since there is a much greater passageway for flow of fluid in this position, the return stroke will experience only minimal damped resistance.

It will be noted that the spigot 18 of the valve body 15 has an outer diameter that is significantly smaller than the internal bore of the O-ring 21. This is desirable, because it creates a relatively large cross-sectional area for flow of fluid, and hence minimises resistance to the return stroke of the damper. This design is enabled by arranging for the restricted passage, ie the grooves 24, to be positioned at an axially spaced location from the O-ring 21. In its extent through the internal bore of the O-ring 21, the spigot 18 occupies a proportion of the cross-sectional area of the O-ring bore of less than half, and preferably less than a third.

The damper seen in FIG. 1 is one in which the free end 11a of its piston rod 11 would typically be connected to a furniture part, for example a drawer, whilst the cylinder 12 would be mounted to another part, for example a cabinet. With such an arrangement, the piston rod 11 will be positively moved in and out of the cylinder 12 by the opening and closing movement of the drawer.

The damper seen in FIG. 4 is different in various respects from the FIG. 1 damper. For one thing, the free end 111a of its piston rod 111 is not designed to be connected to eg a furniture part, but to simply abut against it. In this case, therefore, the damper incorporates a compression spring 150 which is mounted within the cylinder 112 between the end cover 130 and the piston assembly 110. The spring 150 acts via the piston assembly 110 on the piston rod 111 to ensure that it is always biassed to return to its starting position, ready to provide damped resistance on its working stroke.

The design of the piston assembly 110 is also different in the FIG. 4 damper, as seen in more detail in FIGS. 5 and 6. Here, the inner end 111b of the piston rod 111 terminates in a flange 151 with which it simply abuts the end face of the piston assembly 110. The piston assembly 110 is again made in two parts, a main valve body 115 and a cap 116, with a passageway for flow of damping fluid across it. The passageway incorporates a restricted passage for controlling the flow and this again takes the form of axially extending grooves 124 provided as a diametrically opposed pair within a bore 117 in the valve body 115. In this case, an end portion 118a of an axially extending spigot 118 formed on the cap 116 is designed to be received by the bore 117 so as to occlude it. The grooves 124 thus constitute a restricted passage for flow of fluid. The spigot 118 is designed to engage in the bore 117 with a snap-fit connection. Chamber A in the cylinder 112 communicates with the grooves 124 via ports 122 in a flange 119 extending radially from the valve body 115. The grooves 124 open into chamber B via a transverse channel 152 in the end face of the valve body 115.

The piston assembly 110 again comprises a sealing element in the form of an O-ring 121 in sealing engagement with the bore of the cylinder. The O-ring 121 is captured between the flange 119 on the valve body 115 and a radially extending flange 120 on the cap 116, both flanges being of the castellated type of construction described above. The O-ring 121 has the same function as the O-ring 21 in the FIG. 1 damper, ie it controls the flow of damping fluid across the piston assembly. On the working stroke of the damper, the O-ring 121 gets picked up by the flange 119 on the valve body 115, thus creating a seal between the piston assembly 110 and the cylinder. In this condition, the only passageway for flow of fluid across the piston assembly 110 is via the restricted passage, ie the grooves 124. The damper thus produces damped resistance to this movement.

This design of piston assembly has the same advantages as the FIG. 1 damper in terms of its suitability for manufacture. Its damping characteristics are also easy to tailor. For example, the length of the grooves can be varied by simply adjusting the extent of insertion of the spigot 118a into the bore 117 of the valve body 115.

The spigot 118 here is again designed to be significantly smaller than the bore of the O-ring 121 in order to allow a large cross-sectional area for the return flow of fluid. As before, the spigot 118 occupies a proportion of the cross-sectional area of the O-ring bore of less than half, and preferably less than a third.

FIG. 7 shows a modified form of engagement between the piston rod 211 and the piston assembly 210. The piston rod 211 again has a flange 251 with which it abuts the end face of the piston assembly 210. In this case, however, the piston rod 211 has a portion of its inner end 211b extending beyond the flange 251 and into engagement with the bore 217 of the valve body 215. An advantage of this arrangement is that it provides lateral support for the inner end 211b of the piston rod 211 in its reciprocal movement in the cylinder.

FIG. 8 shows a further modified form of engagement between the piston rod 311 and the piston assembly 310. The piston rod 311 again has a flange 351 with which it abuts the end face of the piston assembly 310. Here, the valve body 315 of the piston assembly 310 terminates in a collar 360, which is arranged to capture the flange 351 of the piston rod 311. The collar 360 thus acts to hold the piston rod 311 and the piston assembly 310 together as a unit. As in previous embodiments, the piston assembly 310 comprises an O-ring 321, which is captured between a flange 319 on the valve body 315 and a second flange 320 axially spaced from it.

The form of piston assembly seen in FIG. 9 is similar to that seen in FIG. 2. The difference is in the design of the porting, ie the means of communication of chamber A with the fluid passageway through the piston assembly 410. In this case, communication from chamber A is provided by a single port 422 (as opposed to the pair of ports 22 in the FIG. 2 example). The port 422 is in the form of a groove extending through the flange 419 of the valve body 415 parallel to the axis of the piston assembly. Here the port 422 has a rectangular cross-sectional shape.

The cross-sectional area of the port 422 is relatively small. It therefore has a throttling effect on fluid flowing through it, ie it tends to restrict the flow. Thus, in this example, the port 422 supplements the grooves 424 in providing the restricted passage for controlling the flow of damping fluid on the working stroke of the damper.

As with the grooves 424, the configuration of the port 422 can be varied to determine the damping characteristics of the damper. In particular, its cross-sectional area and/or length can be varied, as can its cross-sectional shape, which could be made to vary along its length, eg in stepped or tapered form.

As with the grooves 424, the port 422 can conveniently be formed by suitable coring, if the piston assembly is formed in an injection moulding process. Forming the piston assembly 410 with the port 422 in this manner enables it to be made with a relatively high degree of accuracy, which is important for producing dampers with prescribed damping criteria. The manner of manufacture also means that it is reliably repeatable on a production line, even though the dimensions of the port will be comparatively small.

The damper seen in FIG. 11 is double ended. It has a piston assembly 510 that is mounted within an elongate cylinder 512 for linear reciprocal movement along a longitudinal axis x, as in the embodiments described above. In this case, however, the damper has two piston rods 511a, 511b which extend respectively to either side of the piston assembly 510. The two piston rods 511a, 511b protrude with their free ends out of either end of the cylinder 512 and engage the piston assembly 510 with their inner ends. Seat assemblies 513a, 513b at the ends of the cylinder 512 provide support for the slidable mounting of respective piston rods 511a, 511b and include suitable seals 514a, 514b to prevent leakage of damping fluid out of the cylinder.

The piston assembly 510 divides the interior of the cylinder 512 into two separate chambers A and B, and is seen in greater detail in FIG. 12. In this case, it is made in three parts: two elongate valve bodies 515a, 515b and a collar 516. Each valve body 515a, 515b is essentially of the same design as the valve body 15 of the piston assembly 10 seen in FIG. 2. Thus, each has an axially extending bore 517a, 517b at one end for receiving the inner end of its respective piston rod 511a, 511b. Grooves 524a, 524b in the respective bores 517a, 517b provide pathways for restricted flow of damping fluid, in a similar manner to the damper of FIG. 2. At their other end, each valve body 515a, 515b has an axially extending spigot 518a, 518b with which they are attached to the collar 516, conveniently by means of snap fittings.

The piston assembly 510 here incorporates two annular sealing elements, each in the form of an O-ring 521a, 521b. Each O-ring 521a, 521b is associated with a respective piston rod 511a, 511b and is captured between a flange 519a, 519b on its respective valve body 515a, 515b and respective flanges 520a, 520b on the collar 516. The O-rings 521a, 521b are designed to control passage of damping fluid across the piston assembly 510, and each operates in essentially the same manner as the O-ring 21 of the damper seen in FIG. 2. Thus, when one of the piston rods 511a, 511b experiences an axial impact, its respective O-ring 521a, 521b will be caused to take up a position where it forms a seal between the cylinder 512 and the flange 519a, 519b of its respective valve body 515a, 515b, leaving only the respective grooves 524a, 524b as a pathway for flow of damping fluid between the two chambers A and B. In this way, inward movement of the impacted piston rod 511a, 511b is effectively opposed by a damped resistive force.

It will be understood that in the double ended damper seen in FIG. 11, inward movement of either piston rod 511a, 511b will be opposed by a damped resistive force, although of course the magnitude of this force may be not necessarily be the same for each piston rod.

It will further be noted that, as with the dampers described above, the restricted pathway through each valve body 515a, 515b of the piston assembly 510, which controls flow of damping fluid between the two chambers A and B, is located at a position axially spaced apart from its respective O-ring 521a, 521b.

The modified form of piston assembly seen in FIG. 13 comprises just two parts: a valve body 615 and a collar 616. The valve body 615 has a bore 617 in which it receives the inner end of one of the two piston rods 611a, with grooves 624 in the bore providing a pathway for restricted flow of damping fluid across the piston assembly, as in the manner described above. The valve body 615 is connected to the collar 616 by means of a snap-fitting spigot 618, and the collar receives the inner end of the other of the two piston rods 611b with an interference fit.

The piston assembly in this case includes an annular sealing element, which is again in the form of an O-ring 621. Here, however, the O-ring 621 is captured between flanges 619 and 620 on respectively the valve body 615 and the collar 616 so as to be in a fixed position relative to the piston assembly. Thus, the damping characteristics of this damper are fixed, and the same in either direction of movement of the piston rods 611a, 611b.

It will be noted again that, as with the dampers described above, the restricted pathway through the valve body 615 of the piston assembly, which controls flow of damping fluid between the two chambers A and B, is located at a position axially spaced apart from the O-ring 621.

The double ended dampers described above may be provided with a compression spring within the cylinder to one or both sides of the piston assembly.

1. A piston and cylinder type damper with a cylinder containing damping fluid having a longitudinal axis and a piston assembly mounted therein for reciprocal movement along said axis, with the piston assembly dividing the cylinder into two chambers and providing a passageway for flow of damping fluid therebetween, the passageway including a control passage for restricting flow of damping fluid, and a sealing element for selectively sealing the piston assembly against the cylinder, with the control passage and the sealing element being positioned at axially spaced apart locations.

2. A damper as claimed in claim 1 wherein the control passage includes one or more grooves on the inner surface of a bore.

3. A damper as claimed in claim 2 wherein the control passage further includes an element located within the bore so as to occlude it.

4. A damper as claimed in claim 3 wherein the damper includes a piston rod and a part of the piston rod forms the element that is located within the bore.

5. A damper as claimed in claim 3 wherein the piston assembly is made of two or more components and a part of one of the components forms the element that is located within the bore.

6. A damper as claimed in claim 3 and further comprising means for limiting the extent of insertion of the element in the bore, whereby to determine the length of the control passage.

7. A damper as claimed in claim 2 wherein the or each groove and the bore extend parallel to the longitudinal axis of the cylinder.

8. A damper as claimed in claim 7 wherein the or each groove is of constant cross-section along its length.

9. A damper as claimed in claim 1 wherein the sealing element comprises an O-ring.

10. A damper as claimed in claim 9 wherein the O-ring is mounted on the piston assembly to be movable between one position in which it seals off the piston assembly against the cylinder and another position in which it does not seal off the piston assembly.

11. A damper as claimed in claim 10 wherein the O-ring is movable relative to the piston assembly in a direction parallel to the longitudinal axis of the cylinder.

12. A damper as claimed in claim 11 wherein the piston assembly has a radially extending first flange for selectively sealing against the O-ring.

13. A damper as claimed in claim 12 wherein the piston assembly comprises a second radially extending flange spaced axially from the first flange, with the two flanges acting as limit stops for the axial movement of the O-ring.

14. A damper as claimed in claim 13 wherein the two flanges are connected by a spigot, with the spigot extending through the internal bore of the O-ring and occupying a proportion of the cross-sectional area of the O-ring bore of less than half, and preferably less than a third.

15. A damper as claimed in claim 14 wherein the or each groove communicates with one of the chambers via a port in the flange adjacent to the spigot.

16. A damper as claimed in claim 15 wherein the port forms an additional part of the control passage.

17. A damper as claimed in claim 12 wherein at least the first flange is of a castellated type of construction.

18. A damper as claimed in claim 1 wherein the damper comprises two coaxially aligned piston rods, each extending from a respective axial end of the piston assembly and protruding out of a respective axial end of the cylinder.

19. A damper as claimed in claim 18 wherein the control passage and the sealing element are arranged to provide restricted flow of damping fluid between the two chambers in either direction of axial movement of the piston rods.

20. A damper as claimed in claim 18 wherein two control passages each with an associated sealing element are incorporated in the piston assembly, one being arranged to provide restricted flow of damping fluid between the two chambers in one direction of axial movement of the piston rods, and the other being arranged to provide restricted flow of damping fluid between the two chambers in the other direction of axial movement of the piston rods.

21. A damper as claimed in claim 20 wherein the respective control passages and their associated sealing elements are arranged provide different amounts of restricted flow of damping fluid.

22. A damper as claimed in claim 5 and further comprising means for limiting the extent of insertion of the element in the bore, whereby to determine the length of the control passage.
